(19) United States
(12) Patent Application Publication
(10) Pub. No.: US 2003/0038137 A1
(43) Pub. Date: Feb. 27, 2003

(54) Baking pan system

(75) Inventor: Jason Tingley, Enon, OH (US)

Correspondence Address: Robert R. Lech, Esq., Calfee, Halter & Griswold, LLP, Suite 1650, 21 East State Street, Columbus, OH, 43215-4243, US

(73) Assignee: AMERICAN PAN COMPANY

(21) Appl. No.: 10/224,171

(22) Filed: Aug. 20, 2002

Related U.S. Application Data
(60) Provisional application No. 60/313,866, filed on Aug. 21, 2001.

(51) Int. Cl. A47J 27/00; A47J 36/00; A47J 37/01

(52) U.S. Cl. 220/573.1

(57) ABSTRACT

A baking pan system is disclosed comprising an outer frame and an attached baking sheet. The outer frame comprises two side walls and two end portions. Each end portion connects corresponding ends of the side walls, and each end portion forms at least one fastening aperture. The baking sheet includes a plurality of extruded portions. Each extruded portion aligns with and pierces a corresponding fastening aperture of the outer frame. Each extruded portion further curls around the outer frame. Methods for fastening a baking sheet to an outer frame and unfastening a baking sheet from an outer frame are also disclosed.

### CROSS-REFERENCE TO RELATED APPLICATIONS

This application claims priority to U.S. Provisional Application entitled “Baking Pan System,” serial No. 60/313,866, filed Aug. 21, 2001, which is incorporated herein by reference in its entirety.

### BACKGROUND OF THE INVENTION

1. Field of the Invention

The described system and method are generally related to vessels for cooking or baking. More specifically, the described system and method relate to baking pans used primarily for commercial production of baquettes and crusty rolls.

2. Description of the Related Art

Baking pans used for commercial production of baguettes and crusty rolls have been available for many years. A typical pan design includes a perforated metal baking sheet that is formed into pockets running parallel to one side of the sheet. These pockets control the side shape of the baked loaf or roll. This baking sheet is then attached to a frame, typically by means of welding or riveting which afford the structural integrity required for commercial baking. Most commonly, aluminum is the desired material for the baking sheet due to its high thermal conductivity, low density, and good corrosion resistance, however stainless steel is occasionally employed. The prior art devices have several deficiencies that affect both the function and the economics associated with the baking pans.

First, aluminum baking sheets can only be welded to aluminum frames and this arrangement lacks the strength needed for many commercial baking environments. In addition, baking sheets that are welded can not be easily separated at a later time to replace a damaged or worn baking sheet.

As an alternative to welding, certain prior art baking pans include aluminum baking sheets attached to a strong steel frame using rivets, but this configuration has several weaknesses as well. Rivets create an unsanitary baking condition around the head of the rivet when located in the baking area. Additionally, rivets are prone to loosen and ultimately fall free of the assembly with usage. It is possible to replace baking sheets if they are riveted to a frame, however, removing rivets requires manual drilling which is a slow and costly process.

Secondly, prior art devices used for baking baguettes and crusty rolls do not have the ability to interlock when stacking the pans. This creates the need for special storage methods to avoid pan stacks from falling over when being transported within the bakery.

### SUMMARY OF THE INVENTION

The present invention results in a baking pan that overcomes the aforementioned problems of the prior art devices. According to a first aspect of the present invention, a bakin pan system is described that comprises an outer frame and an attached baking sheet. The outer frame comprises two side walls and two end portions. Each end portion connects corresponding ends of the side walls, and each end portion forms at least one fastening aperture. The baking sheet includes a plurality of extruded portions. Each extruded portion aligns with and pierces a corresponding fastening aperture of the outer frame. Each extruded portion further curls around the outer frame.

According to a second aspect of the present invention, a method for fastening a baking sheet to an outer frame is disclosed. The method includes providing an outer frame and a baking sheet. The method also includes piercing end portions of the outer frame to form a plurality of fastening apertures. The method further includes aligning the baking sheet with the outer frame, and die piercing the baking sheet at a plurality of fastening locations. Each fastening location corresponds to a fastening aperture of the outer frame. The baking sheet is extruded through the plurality of fastening apertures, and the extruded portions of the baking sheet are curled around the outer frame. According to a second aspect of the present invention, a method for unfastening a baking sheet from an outer frame is disclosed. The method includes providing a baking sheet fastened to an outer frame. Portions of the baking sheet pierce fastening apertures formed by the outer frame at a plurality of fastening locations. The method further includes die piercing the baking sheet at each fastening location using a die having a diameter at least as small as the diameter of the fastening aperture.

The present invention results in a baking sheet that is attached to a frame in such a way as to enable easy and economical removal of the baking sheet to allow for replacement of the baking sheet due to wear or damage. The fastening method of the present invention eliminates the unsanitary conditions normally encountered with rivets. Further, the system and method of the present invention can be adapted to any desired size or shape of baking pan.

The objects, features and advantages of the present invention are readily apparent from the following description of the preferred embodiments when taken in connection with the accompanying drawings.

### BRIEF DESCRIPTION OF THE DRAWINGS

Comprehension of the invention is facilitated by reading the following detailed description, in conjunction with the associated drawings, in which:

FIG. 1 is a perspective view comprising the baking sheet that is locked to the outer frame assembly;

FIG. 2 is a cross section through the interlocking rib of the outer frame assembly and the baking sheet;

FIG. 3 is a cross section of two (2) frames engaged by the interlocking ribs;

FIG. 4 is a cross section of the locking method used to attach the baking sheet to the outer frame assembly; and

FIG. 5 is a bottom view of the locking method used to attach the baking sheet to the outer frame assembly.

### DETAILED DESCRIPTION OF THE DRAWINGS

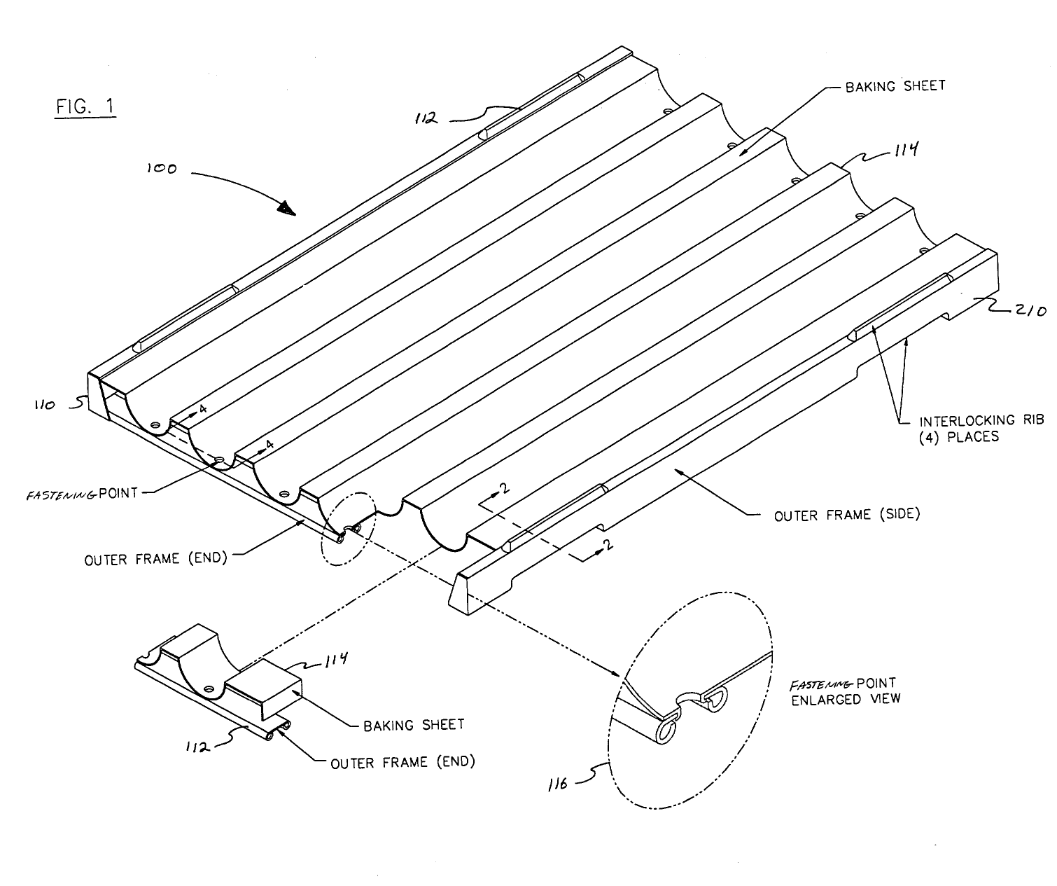

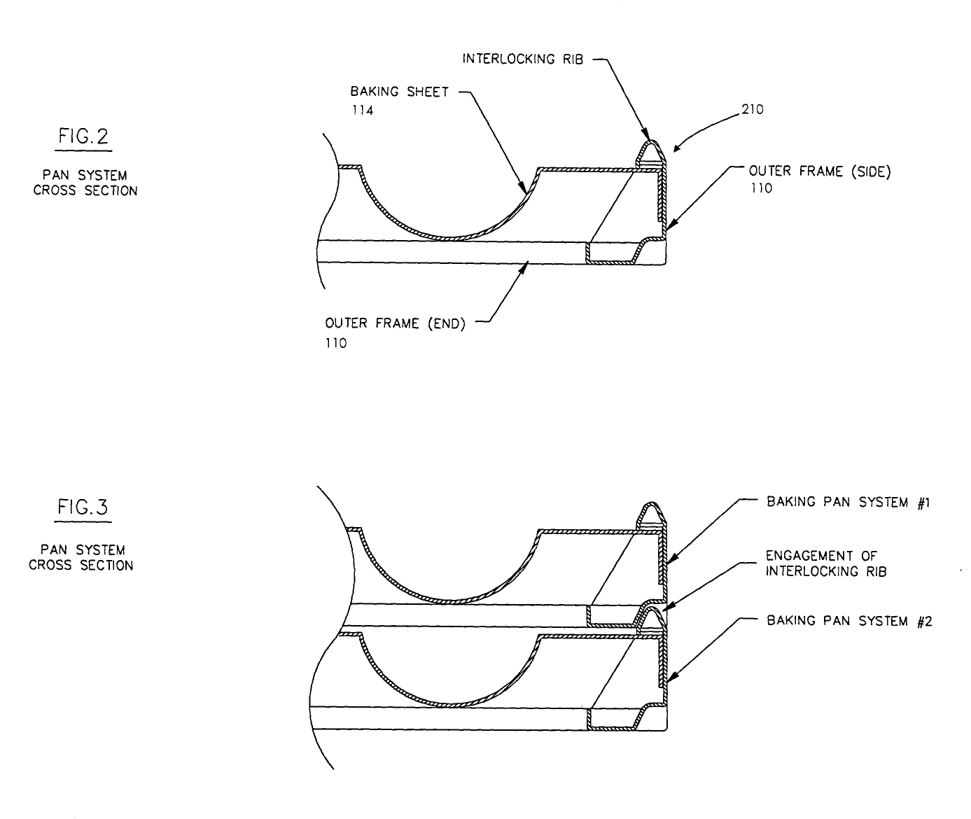

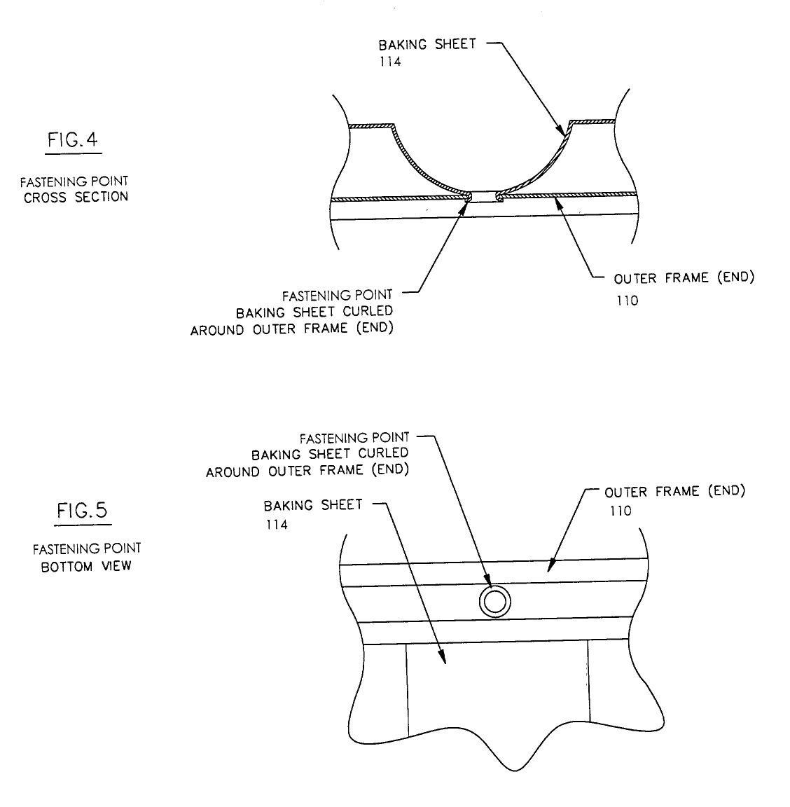

The baking pan system and method of the present invention can be best understood by reference to the drawings. As illustrated in FIG. 1, the baking pan system 100 comprises a metallic framework 110 that includes interlocking ribs 112 to provide positive stacking. Preferably, the leading top edge of the framework 210 is double wall thickness to reinforce the stacking surface of the framework 110 and secure the sides of baking sheet 114, as shown more fully in FIG. 2. The interior baking sheet 114 is attached to the framework 110 by directly fastening the ends of the sheet to the framework 110 as shown at reference numeral 116. The illustrations of FIG. 4 and FIG. 5 detail the arrangement of the fastening method for the baking sheet.

It will be recognized by one skilled in the art that it is desirable to use a metal of sufficient strength and corrosion resistance in constructing the framework 110 to withstand the rigors of the baking environment. The system of this invention can be formed from any desired metal combination of baking sheet 114 and framework 110 to provide the best performance for a specific baking application.

Although exemplary baking sheet 114 is shown formed into fluted pockets, the present invention is not limited to such a configuration. Baking sheet 114 can be of any configuration including a flat, horizontal sheet. Similarly, baking sheet 114 can be comprised of any metal, either solid or perforated, to optimize the specific baking application as apparent to one skilled in the art.

In the fastening process, baking sheet 114 is extruded at discrete attachment locations and is curled around the framework 110 at corresponding locations which may be advantageously determined according to the baking sheet geometry and operating conditions of the baking pan. The described fastening method is applicable to all metals that are suited to both the baking environment and the manufacturing process. The step of curling should be performed so as to provide sufficient force to fasten baking sheet 114 and frame 110 securely without undue thinning of the baking sheet material. While the step of curling is described separately from the steps of piercing and extruding, it should be recognized that these steps, or a subset of these steps, may be combined into a single operational step.

Removal of the baking sheet 114 from the framework 110 at an attachment location can be accomplished through die cutting of only the baking sheet material without disturbing the geometry of the hole in the framework 110. The baking sheet 114 can also be removed from the framework 110 at an attachment location through manual drilling, though this method is generally associated with a greater cost. Once the baking sheet 114 is completely removed from the framework 110, the baking sheet 114 can be removed and a new baking sheet 114 can be installed in the same manner to form a new baking pan system.

The preferred method for fastening the baking sheet 114 to the framework 110 includes the steps of:

Piercing the completed framework 110 on the ends at desired attachment locations for the fastening points;

Inserting the baking sheet 114 into the framework 110;

Die piercing and extruding the baking sheet 114 through the existing holes at the attachment locations in the framework ends; and

Curling the extruded portions of the baking sheet 114 around the framework holes, using press tooling, to secure the baking sheet 114 to the framework 110.

When piercing and extruding the baking sheet 114 through the holes in the framework 110, it is desirable to extrude with less than material clearance between the extrude punch and the existing holes. In this manner, the baking sheet 114 will be attached to the framework 110 until the final curling operation fastens the baking sheet 114 and framework 110 securely. Preferably, the method employs an extrude punch that is 2-3% oversize. The precise diameter used for the fastening points is not critical, however smaller diameters increase the difficulty of extruding and curling the baking sheet 114. It will be recognized by one skilled in the art that a smaller diameter is preferred for the invention described herein. A good choice for the inner diameter of the locking points is generally 0.350″. Any number of fastening points can be made in a single machine cycle providing an appropriate press/tooling combination is utilized.

The preferred method for removing the baking sheet 114 from the framework 110 includes the steps of:

Orienting the pan system from the existing locking points;

Die piercing the baking sheet through the fastening points without affecting the framework holes; and

Removing and discarding the baking sheet.

With the baking sheet 114 removed, a new baking sheet 114 can be secured to the framework 110 following the same attachment method described above. The preferred piercing punch for removing the baking sheet 114 is 1-2% smaller than the existing holes in the framework 110. In this manner, the extruded portion of the baking sheet 114 is pierced without altering the hole in the framework 110. Any number of fastening points can be removed in a single machine cycle providing an appropriate press/tooling combination is utilized.

Although the invention has been described in terms of specific embodiments and applications, persons skilled in the art can, in light of this teaching, generate additional embodiments without exceeding the scope or departing from the spirit of the claimed invention. Accordingly, it is to be understood that the drawing and description in this disclosure are proffered to facilitate comprehension of the invention, and should not be construed to limit the scope thereof.

What is claimed is:

1. A baking pan system comprising:
an outer frame comprising two side walls and two end portions, each end portion connecting corresponding ends of the side walls, each end portion forming at least one fastening aperture; and
a baking sheet attached to the outer frame, the baking sheet including a plurality of extruded portions, each extruded portion aligning with and piercing a corresponding fastening aperture of the outer frame, each extruded portion further curling around the outer frame.

2. The baking pan system of claim 1, wherein the outer frame forms at least one rib to cooperate with a first adjacent baking pan system, and the outer frame further forms at least one cavity to cooperate with a second adjacent baking pan system.

3. The baking pan system of claim 2, wherein the top portion of the side walls have a thickness greater than the end portions.

4. The baking pan system of claim 1, wherein the baking sheet forms at least one fluted pocket.

5. A method for fastening a baking sheet to an outer frame, comprising:
providing an outer frame and a baking sheet;
piercing end portions of the outer frame to form a plurality of fastening apertures;
aligning the baking sheet with the outer frame;
die piercing the baking sheet at a plurality of fastening locations, each fastening location corresponding to a fastening aperture of the outer frame;
extruding the baking sheet through the plurality of fastening apertures; and
curling extruded portions of the baking sheet around the outer frame.

6. The method of claim 5, wherein the step of extruding is performed with less than material clearance between the extruded portions and the corresponding fastening apertures of the outer frame.

7. The method of claim 5, wherein the step of extruding is performed using a punch that is between two and three percent larger than the corresponding fastening aperture of the outer frame.

8. The method of claim 5, wherein the inner diameter of each fastening aperture is 0.350 inches.

9. A method for unfastening a baking sheet from an outer frame, comprising:
providing a baking sheet fastened to an outer frame, portions of the baking sheet piercing fastening apertures formed by the outer frame at a plurality of fastening locations; and
die piercing the baking sheet at each fastening location using a die having a diameter at least as small as the diameter of the fastening aperture.

10. The method of claim 9, wherein the step of die piercing is performed using a die between one and two percent smaller than the diameter of the fastening aperture.
